(19) United States
(12) Patent Application Publication
(10) Pub. No.: US 2007/0077478 A1
(43) Pub. Date: Apr. 5, 2007

(54) Electrolyte membrane for fuel cell utilizing nano composite

(75) Inventors: Khe C. Nguyen, Ho Chi Minh City (VN); Huong V. Nguyen, Binh Duong (VN); Truc C. Pham, Ho Chi Minh City (VN)

Correspondence Address: LEWIS AND ROCA LLP, 40 NORTH CENTRAL AVENUE, PHOENIX, AZ, 85004, US

(73) Assignee: The Board of Management of Saigon Hi-Tech Park

(21) Appl. No.: 11/242,816

(22) Filed: Oct. 3, 2005

(51) Int. Cl. H01M 8/10; H01M 4/94

(52) U.S. Cl. 429/33; 429/13; 429/44

(57) ABSTRACT

An electrolyte membrane is disclosed, for use in a fuel cell, and is composed of ionic transporting elements embedded in a polymer matrix. The elements can be carbon products, dye stuffs molecules, organic molecules, inorganic molecules, semiconductors, oxides, or superconductors. The elements carry ionic groups by chemical attachment of physical absorption. The electrolyte membrane can be a homogeneous or inhomogeneous blend of the ionic transporting elements in the polymer matrix. An anode and an opposing cathode are on opposite sides of the membrane. Respective catalysts are on the anode and cathode. A gas diffusion layer contacts the anode and has openings to allow fuel from a fuel source to pass through to the anode, as fuel is consumed at the anode. Another gas diffusion layer contacts the cathode and has openings to allow oxygen to pass through to the cathode. Fuel consumption generates electricity and produces water.

### FIELD

The present invention relates generally to fuel cell, and is more particularly related to an electrolyte membrane utilized in fuel cell or battery fields.

### BACKGROUND

NAFION™ products from Dupont is a typical example of an electrolyte membrane utilized in a fuel cell of the prior art. NAFION™ is a derivative of the tetrafluoro ethylene polymer (TEFLON™). TEFLON™ itself is a water repellent material and had found suitable applications in anti-adhesion, non-sticking applications, and classified as low surface energy materials. The modification of TEFLON™ with sulfonic acid group —SO₃H makes the modified TEFLON™ become ionic conductive and turns it into an effective proton exchange membrane. However, the trade-off is the poor water resistance, especially at high temperature such as above 120 C as NAFION™ film becomes more soluble.

Another issues related to NAFION™ is the poor film forming due to the non-sticking properties of fluoro components. Many efforts have been made to resolve this issue as reported in U.S. Pat. Nos. 6,939,646; 5,837,125; 6,010,798; 6,264,857; 6,288,187; and 6,465,129. However, it ends up to expensive process and poor scale up capability or poor performance in terms of output voltage and current density, rising time, cost. The process of scale up, thus, turns into expensive film products and Fuel Cell material cost becomes more and more expensive.

It would be an advantage in the art to ameliorate the above problems as related to an electrolyte membrane in a fuel cell. It would further be an advantage in the art to provide an electrolyte membranes in a fuel cell that provided effective ion transfer and ion transport properties, provided a durable electrolyte membrane in a various condition of operating environment (anti penetration), provided excellent film forming properties for large scale production, and would be less costly than prior art electrolyte membranes and their respective fuel cells.

### SUMMARY

The present disclosure provides ionic transporting nano elements in an electrolyte membrane. The ionic transporting nano elements are can be embedded in a polymer matrix so as to form a nano composite, where the elements are the core components of the electrolyte membrane. In order to provide ionic transport properties, the nano components of the nano composite must carry ionic transporting groups such, as but not limited to, —SO3H, —COOH, —NH2, —NH, —N, —OH, and/or any acid and base salts. These salts, for instance, can be, but are not limited to carbonium salt, pyrrylium salt, iodonium salt, sulfonium salts, ammonium salt, phosphonium salt, tetrazolium salt, diazonium salt, etc. By way of example, and not by way of limitation, the ionic transporting molecules can be cited as amino acids and/or amino acids salts.

These and other features of the present invention will become more fully apparent from the following description and appended claim, or may be learned by the practice of the invention as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 shows an exemplary AFM image, taken in stepping mode, of an ionic transporting nano carbon material, where the average particle size is from about 20 nm to about 30 nm;

FIG. 2 shows an exemplary graph of an infrared (IR) absorption spectra of the raw carbon black material from a burned palm wicker product, where the product has a ionic transporting properties via the presence of nano carbon P1 and carbon P4, where the graph reveals an attachment of —CH2-SO3H onto the raw carbon black material from the burned palm wicker product, and where transmittance is shown on the Y axis and wave number in the units of cm⁻¹ is shown on the X axis; and

FIG. 3 shows an exemplary implementation of a fuel cell assembly having an electrolyte membrane that is composed of a nano composite.

### DETAILED DESCRIPTION

Implementations provide an electrolyte membrane for a fuel cell. The electrolyte membrane has a composite composed of ionic transporting elements and a polymer matrix. The ionic transporting elements can be various elements, including but not limited to carbon products, dye stuffs molecules, organic molecules, inorganic molecules, semiconductors, oxides, or superconductors. The ionic transporting elements carry ionic groups that are chemically attached onto the elements or that are physically adsorbed onto the elements.

By way of example, and not by way of limitation, the carbon products can be activated carbon, carbon nano tubes, carbon nano horns, carbon black, graphite, fullerenes (e.g.; buckyballs), diamonds, various coals (wood coal, charcoal, mudcoal, etc.), thermally decomposed products or burned products that are composed of carbon atom containing materials such as, but not limited to, hydrocarbons, aliphatic and aromatic compounds, cellulose products such as palm wicker, coconut shell, paddy shell, pine wood, oil products such as diesel oils, kerosene oils, rubber, polymer products, and sugars and sugar derivatives.

The ionic transporting elements can also have the fuctionality of acids, alcohols, aldehydes, ketones, nitros, aminos, iminos, etc.

The composite of the electrolyte membrane, as referred to above, can be a homogeneous or inhomogeneous blend of ionic transporting element in the polymer matrix. The ionic transporting elements will preferably have a particle size in a range from about 500 microns to about 1 nanometer.

Ionic transporting elements can be used in a combination with a variety of different polymers, examples of which include polyaminoacids, emulsion polymers, ionic polymers, water soluble polymers, organic solvents soluble polymers, fluoropolymers, liquid crystal polymers, crosslinking polymers, network polymers, blend polymers, copolymers, and electronic conductive polymers. For the polymeric content of the composite will preferably be from about 0% wt to about 99.99% wt, and more preferably from about 0.1% wt to about 90% wt, and most preferably from about 0.1% wt to about 80% wt.

The ionic transporting elements can be formed in the composite of the electrolyte membrane via a heat treatment process. The heat treatment process will preferably be conducted in temperature range from about 100° C. to about 1600° C. in various environments, including both an oxygen free environment and an oxygen rich environment.

The ionic transporting elements can either be alone or with additives. These additives can be acids, bases, electron acceptor molecules (p⁺), and electron donor molecules (n⁻), or a combination thereof. The electrolyte membrane can be used with any conventional electrocatalysts without additives or with additives. As above, the additives can be acids, bases, electron acceptor molecules (p⁺), and electron donor molecules (n³¹ ), or a combination thereof. Moreover, the ionic transporting elements can be used in a combination with crosslinkers, or in a combination with other ionic species such as dyes stuffs, surfactants, and charge control agents (CCA).

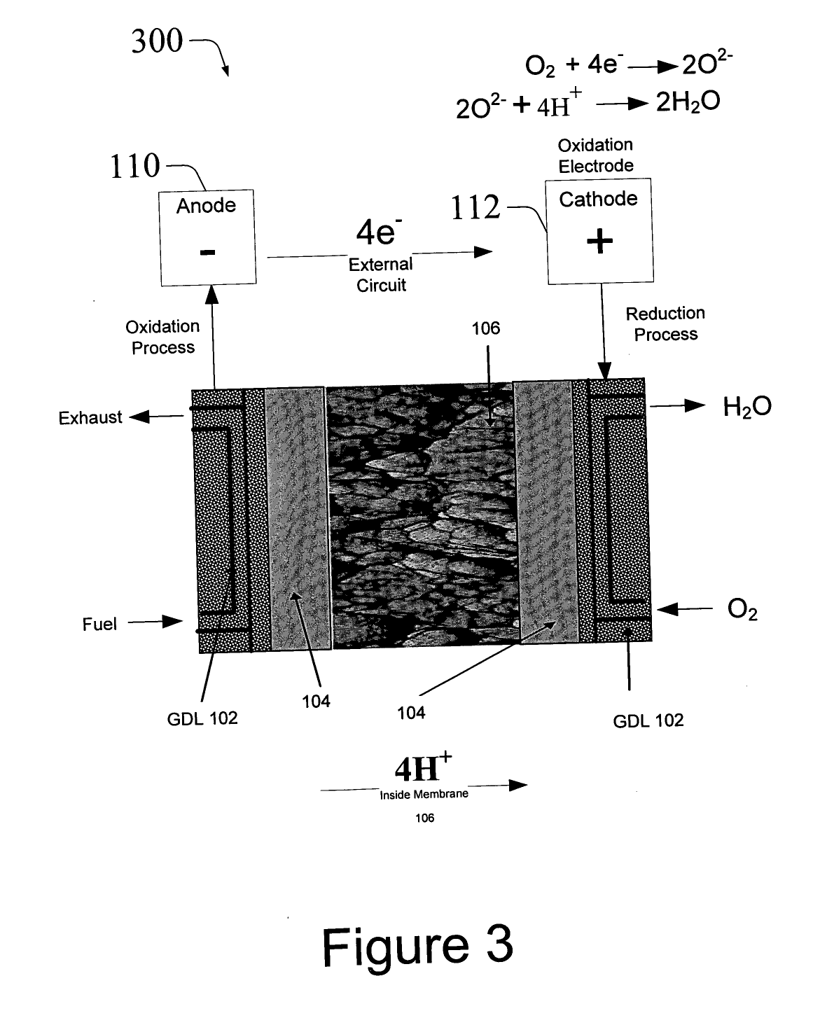

In one implementation, an example of which is seen in FIG. 3, a fuel cell 300 has an electronically non-conductive membrane 106 that includes a polymeric binder having embedded nanoparticles that render the membrane conductive to ionic groups (e.g., anions, cations, switter ions, and combinations thereof). An anode 110 and an opposing cathode 112 are on opposite sides of the membrane 106. Respective catalysts 104 and 105 are on the anode 110 and the cathode 112. Catalyst 104 and 105 will be identical if the fuel is hydrogen. A gas diffusion layer 102 contacts the anode and has openings to allow fuel from the fuel source to pass through to the anode 110, as fuel is consumed at the anode 110. A gas diffusion layer 102 contacts the cathode 112 and has openings to allow oxygen to pass through to the cathode 112.

In the above implementation, fuel from a fuel source is introduced into the openings in the gas diffusion layer contacting the anode so as to contact the catalyst on the anode. Oxygen is introduced into the openings in the gas diffusion layer contacting the cathode so as to contact the catalyst on the cathode. As such, an electricity-generating reaction occurs as the fuel is consumed at the anode 's catalyst by an anodic dissociation of the fuel into protons, electrons, and a gaseous reaction product, and by a cathodic combination of protons, electrons, and the oxygen, thereby producing water. In the fuel cell incorporating an electrolyte membrane, implementations provide for fuel cells capable of operating on a variety fuel sources, including hydrogen, methanol, ethanol, and propanol. The electrolyte membrane can contain a biocide and implementations there can transport electrons, protons, or both electrons and protons.

An electrocatalyst can be formed on the electrolyte membrane by physical vapor deposition (PVD) or sputtering, vacuum sublimater, or by coating the dispersion fabricated by microfluidizer without using milling media. The microfuidizer can avoid the electrocatalyst contamination caused by milling media.

As noted above, ionic transporting nano elements can be alone in the electrolyte membrane or they can be embedded in a polymer matrix that forms the composite of the electrolyte membrane. In order to provide ionic transport properties, the nano components of the nano composite must carry ionic transporting groups. By way of example, and not by way of limitations, these ionic transporting groups include —SO3H, —COOH, —NH2, —NH, —N, the group —OH, and/or any acid salts and base salts. The base salts include, but are not limited to carbonium salt, pyrrylium salt, iodonium salt, sulfonium salts, ammonium salt, phosphonium salt, tetrazolium salt, and diazonium salt. Examples of ionic transporting molecules include, but are not limited to amino acids, 3-Aminoadipic acid, 2-aminobenzenearsonic acid, 3-aminobenzenesulfonic acid, sulfanilic acid, 4-aminobenzoic acid, (1-Aminobutyl) phosphonic acid, 4-aminobutyric acid, 6-aminohexanoic acid, 8-aminocaprylic acid, 4-amino-2-chorobenzoic acid, 4-amino-3,5-dibromobenzenesulfonic acid, 1-amino-1-cyclopropanecarboxylic acid, 4,5-Difluoroanthranilic acid, 4-Aminodiiodobenzoic acid, 2-aminoethanesulfonic acid, 4-amino-3-hydroxy-1-napthalenesulsulfonic acid, aminomethanesulfonic acid, amino-1-napthalenesulfonic acid, aminohydroxynapthalenesulfonic acid, aminophenylacetic acid, 3-Aminophthalic acid, 2-aminotoluene-3-sulfonic acid, a polymer of acid and base salts such as poly (vinyl sulfate, potassium salt), dye stuff molecules carrying ionic transporter functions such as nitro blue tetrazolium chloride monohydrate, acid alizarin violet N, acid black 24, acid blue 25, acid blue 29, acid blue 40, acid blue 45, acid blue 80, acid blue 92, acid blue 113, acid blue 120, acid green 25, acid green 27, acid orange 8, acid orange 51, acid orange 52, acid red 1, acid red 4, acid red 8, acid red 37, acid red 97, acid red 114, acid red 151, acid red 183, acid yellow 1, acid yellow 3, acid yellow 9, acid blue 9, acid yellow 11, acid yellow 17, acid yellow 23, and acid Yellow 42. Under certain condition, these molecules can form nano particles on dried film after being casted and baked from dissolving solvent(s). These molecules can be used alone or can be embedded in a polymer matrix to form an ionic transporting nano composite membrane.

Besides the ionic transporting molecules above cited, ionic transporting nano elements can be found in carbon products carrying ionic groups including anions, cations and switter ions can be as effective as acid and/or base salts. Carbon products usually are aromatic compounds with a large density of carbon atoms. The attachment of suitable chemical functional groups onto the carbon products can render the carbon products into an ionic transporter. The attachment can be done through a number of chemical reactions well known in the art of aromatic compound chemistry such as hydroxylation, sulfonation, diazo coupling, etc. The carbon products carrying ionic groups chemically attached, can be found from commercialized products such as Cabojet 200 and Cabojet 300 from Cabot Corporation. The carbon products carrying ionic groups physically attached can be prepared by mixing carbon black with ionic surfactant or ionic polymers.

Carbon products themselves, as above mentioned, are activated carbon, carbon nano tubes, carbon nano horns, carbon black, graphite, fullerenes (buckeyballs), diamonds, wood coal, charcoal, mudcoal, thermally decomposed products or burned products including of carbon atom containing materials such as, but not limited to:
a) hydrocarbons, aliphatic and aromatic compounds, etc.
b) cellulose products such as palm wicker, coconut shell, paddy shell, pine wood, etc.
c) oil products such as diesel oils, kerosene oils, rubber and rubber waste;
d) any kinds of polymer products; and
e) sugars and sugar derivatives.

Carbon products are usually electronic conductor with a bulk resistivity that varies between about 10⁻³ Ohm-cm to about 10² Ohm-cm. The attachment of ionic groups onto the carbon products significantly increases the bulk resistivity up to the range between about 10⁴ Ohm-cm to about 108⁸ Ohm-cm. The surface resistivity of ionic transporting carbon products can also vary with the density of ionic groups attached onto it. For example, increasing the concentration of —SO3H in the Cabojet 200 by multiple repeating of the diazo coupling of sulfanilic acid with Cabojet 200 can reduce the electrical resistivity by one to two orders of magnitude. The attachment of an ionic transporter onto specific carbon products as mentioned above mentioned can occur, first, by attaching acidic groups or amine groups, then by converting it into a salt. The attachment can be done through a number of well-known chemical reaction route described somewhere in organic chemistry books, for example, Advanced Organic Chemistry, Kluwer Academic/Plenum Publishers, 4th edition, edited by Francis A. Carey and Richard J. Sunberg. Preferably, the route used will be a diazo coupling reaction of an aromatic compound, as described on page 714 of the foregoing text. The diazo coupling reaction onto aromatic compounds has been known, as explained in U.S. Pat. Nos. 4,666,805; 4,755,443; 4,983,480; 5,554,739; and 5,922,118.

Diazonium salt has been known to exhibit a nucleophilic reaction with an aromatic ring to form a coupling. As result, many coupling products have been known in the color imaging and blue print technologies, and recently in the photoconductor technology. Chloro Dian blue, a diazo coupling product, is a well known example of a coupling reaction of a specific diazonium salt and a specific coupler, and fluorenone bisazo is another example. As disclosed in U.S. Pat. No. 4,618,672, diaminofluorenone was diazotized into diazonium salt under low temperature (0° C.). The coupling reaction occurs at a phenyl ring to form a fluorenone bisazo pigment when the reaction temperature was raised up to 80° C. According to the U.S. Pat. No. 5,554,739, the diazo coupling reaction can occur on carbon products by replacing bi-fuictional diazonium salt with a mono-finctional one carrying the desired functional group to be attached to the carbon product. The specific primary amine can attach an ionic transporter onto carbon products as follows: amino acids, 3-Aminoadipic acid, 2-aminobenzenearsonic acid, 3-aminobenzenesulfonic acid, sulfanilic acid, 4-aminobenzoic acid, (1-aminobutyl) phosphonic acid, 4-aminobutyric acid, 6-aminohexanoic acid, 8-aminocaprylic acid, 4-amino-2-chorobenzoic acid, 4-amino-3,5-dibromobenzenesulfonic acid, 1-amino-1-cyclopropanecarboxylic acid, 4,5-difluoroanthranilic acid, 4-aminodiiodobenzoic acid, 2-aminoethanesulfonic acid, 4-amino-3-hydroxy-1-napthalenesulsulfonic acid, aminomethanesulfonic acid, 4-amino-1-napthalenesulfonic acid, aminohydroxynapthalenesulfonic acid, aminophenylacetic acid, 3-aminophthalic acid, 2-aminotoluene-3-sulfonic acid, etc.

Ionic transporting nano elements can be found from semiconducting, superconducting, electron transport molecules, hole transport molecules and oxides particles that are chemically attached with or physically adsorbed with ionic transporting species. In these cases, these combined systems can be embedded into a polymer matrix to form a nano composite having ionic transporting functions. The nano scale particles of superconductors, semiconductors, electron transport molecules, hole transport molecules and oxides are usually prepared by a gas phase or a liquid phase reaction (sol-gel process) that yields nano products such as SiO₂, Al₂O₃, TiO₂, In₂O₃, SnO₄, ZnO, ZrO₂, CdS, CdTe, SeTe, As₂Se₃, Si, a-Si, SiGe, GaAs, compounds derived from the yttrium-barium-copper-oxygen (Y—Ba—Cu—O), bismuth-strontium-calcium-copper-oxygen (Bi—Sr—Ca—Cu—O), thallium-strontium-calcium-copper-oxygen (Ti—Sr—Ca—Cu—O), and lanthanum-copper-oxygen (La—Cu—O) chemical families.

The ionic transporting functional groups, in general, are surrounded by small organic molecules which perform intramolecular interaction and yield film forming properties. Thus, the ionic transporting species can form a film directly by themselves without the aid of a polymeric binder material. However, in some cases, there may be a need to blend ionic transporter nano particles with certain a kind of binder. The binder must play the role of forming a film, so as to form a barrier to a crossover fluid, thereby protecting the ionic transporting layer, as well as providing a desirably degree of the wetness the for good dispersion of nano particles into the matrix medium of the electrolyte membrane.

As mentioned above, the electrolyte membrane can include a polymeric binder. The polymeric binder can have the following characteristics:
a) Polyamino acids such as but not limited to gelatin, protein, egg albumin, collagen, casein, polygamma-benzylglutamate, poly glycine, poly L-proline, and copolymers of the single polymers. These polymers can be used alone or in a blend polymer, with and without crosslinkers.
b) Latex emulsion polymers and copolymers of vinyl monomers such as but not limited to ethylene, styrene, vinyl carbazole, vinyl acetate, vinyl naphthalene, vinyl anthracene, vinyl pyrene, methyl methacrylate, methyl acrylate, alpha-methyl styrene, dimethylstyrene, methylstyrene, vinylbiphenyl, glycidyl acrylate, glycidyl methacrylate, glycidyl propylene, 2-methyl-2-vinyl oxirane, vinyl pyridine, aminoethyl methacrylate, vinyl pyrrolidone, vinyl chloride, vinylidene fluoride, vinyl sulfonic acid metal salts, ethyl methacrylate, benzyl acrylate, benzyl methacrylate, propyl acrylate, propyl methacrylate, iso-propyl acrylate, iso-propyl methacrylate, butyl acrylate, butyl methacrylate, hexyl acrylate, hexyl methacrylate, octadecyl methacrylate, octadecyl acrylate, lauryl methacrylate, lauryl acrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, phenethyl acrylate, phenethyl methacrylate, 6-phenylhexyl acrylate, 6-phenylhexyl methacrylate, phenyllauryl acrylate, phenyllauryl methacrylate, 3-nitrophenyl-6-hexyl methacrylate, 3-nitrophenyl-18-octadecyl acrylate, ethyleneglycol dicyclopentyl ether acrylate, vinyl ethyl ketone, vinyl propyl ketone, vinyl hexyl ketone, vinyl octyl ketone, vinyl butyl ketone, cyclohexyl acrylate, 3-methacryloxypropyldimethylmethoxysilane, 3-methacryloxypropylmethyldimethoxysilane, 3-methacryloxypropylpentamethyldisiloxane, 3-methacryloxypropyltris(trimethylsiloxy)silane, 3-acryloxypropyldimethy,methoxysilane, acryloxypropyhiethyldimethoxysilane; trifluoromethyl styrene; trifluoromethyl acrylate, trifluoromethyl methacrylate, tetrafluoropropyl acrylate, tetrafluoropropyl methacrylate, heptafluorobutyl methacrylate, iso-butyl acrylate, iso-butyl methacrylate, 2-ethylhexyl acrylate, 2-ethylhexyl methacrylate, iso-octyl acrylate, iso-octyl methacrylate, aminoethylphenyl acrylate, vinyl butyral, poly(ethylene glycol) methyl ether acrylate; poly(ethylene glycol) methyl ether methacrylate; poly(ethylene glycol) methyl ether methacrylate; poly(ethylene glycol) methyl ether acrylate; polyvinyl alcohol; vinyl pyrrolidone; vinyl 4-methylpyrrolidone; vinyl 4-phenylpyrrolidone; vinyl imidazole; vinyl 4-methylimidazole; vinyl 4-phenylimidazole; acrylamide; methacrylamide; N,N-dimethyl acrylamide; N-methyl acrylamide; N-methyl methacrylamide; aryloxy piperidine; and N,N-dimethyl acrylamide.
c) Crosslinking polymers including UV curable resins (negative photoresists, polyamic, photoimageable polyimides, Benzocyclobutane polymer (Dow Chemical), diacrylate polymers, aliphatic urethane acrylate oligomer (Ebeccryl 2001 from Cytec), polyethylene glycol diacrylate (Ebecryl 11), water soluble alkoxylayed triacrylate (Ebecryl 12), thermal crosslinking polymers (polyurethane with hardener, epoxy resins, polyimides, PMDS, phenolic resins, hydroxylated polyesters, hydroxylated polystyrene, formaldehyde polymer, PVB, Cytec products such as Ebecryl 2001 (Aliphatic urethane acrylate oligomer), Ebecryl 11 (polyethylene glycol diacrylate), Ebecryl 12 (water dilutable alkoxylated triacrylate),Ebecryl 2002 (Aliphatic urethane diacrylate), Ebecryl 2100, Ebecryl 360 (Silicone diacrylate), Ebecryl 1215 (Silicone derivatives), Ebecryl 1360 (Silicone hexaacrylate), water curable resine, low temperature cure polymer, high energy beam trradiation curable resin, and aldehyde polymer.
d) Fluoro polymers: polyvinylfluorovinilidene, teflon, sulfonated teflon (Nafion™ from the Dupont company in the USA)
e) Ionic polymers (Poly(sodium 4-styrenesulfonate), Nafion™ (sulfonated Teflon™), polysulfone (PS), polybenzimidazole(PBI), polyetherether ketone (PEEK), poly(acrylic acid, sodium salt), Poly(acrylamide-co-acrylic acid), potassium salt, Poly(acrylic aciñ-co-maleic acid), sodium salt, Poly(acrylic aciñ) 1 sodium salt-graft-poly(ethylene oxide)-co-maleic acid), Poly(anetholesulfonic acid, sodiumsalt), poly(anilinesulfonic acid), Poly(isobutylene-co-maleic acid), sodium salt, Poly(styrenesulfonic aciñ-co-maleic acid), sodium salt, poly(vinylsulfonic acid, sodium salt), poly(styrene-co-vinylsulfonic acid)
f) Water soluble polymers (poly(acrylic acid), polyacrylamide, Poly(acrylamide-co-acrylic acid), Poly(acrylamide-co-acrylic acid), Poly(acrylic aciñ-co-maleic acid), net-Polyacrylic-inter-net-polysiloxane, Poly(allylamine), Poly(diallyldimethylammonium chloride), Poly(diethylene glycol)/cyclohaxanedimethanol-alt-isopthalic acid, sulfonated, Polyethylene glycol, Poly(ethyleneglycol)n-alkyl 3-sulfopropyl ether, potassium salt, polyethyleneimine, polypropyleneimine, polyvinyl pyrrolidone, poly(4-vinylpyridine), poly(ethylene glycol)methyl ether acrylate; poly(ethylene glycol)methyl ether methacrylate; poly(ethylene glycol)methyl ether methacrylate; poly(ethylene glycol)methyl ether acrylate; polyvinyl alcohol; vinyl pyrrolidone; vinyl 4-methylpyrrolidone; vinyl 4-phenylpyrrolidone; vinyl imidazole; vinyl 4-methylimidazole; vinyl 4-phenylimidazole; acrylamide; methacrylamide; N,N-dimethyl acrylamide; N-methyl acrylamide; N-methyl methacrylamide; aryloxy piperidine; and N,N-dimethyl acrylamide.
g) High Tg polymers (polyN-vinyl carbazol), poly carbonate, poly ester, polyimides, acrylic resin, poly styrene and derivatives.
h) Solvent soluble polymers and copolymers: ethyl acrylate; ethyl methacrylate; ethyl butacrylate; benzyl acrylate; benzyl methacrylate; propyl acrylate; propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicycopentyl ether acrylate; vinyl ethyl ketone; vinyl propyl ketone; vinyl hexyl ketone; vinyl octyl ketone; vinyl butyl ketone; cyclohexyl acrylate; 3-methacryloxypropyldimethylmethoxysilane; 3-methacryloxypropylmethyldimethoxysilane; 3-methacryloxypropylpentamethyldisiloxane; 3-methacryloxypropyltris(trimethylsiloxy)silane; 3-acryloxypropyldimethylmethoxysilane; acryloxypropylmethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; N,N-dihexyl acrylamide; N,N-dioctyl acrylamide; aminoethyl acrylate; aminoethyl methacrylate; aminoethyl butacrylate; aminoethylphenyl acrylate; aminopropyl acrylate; aminopropyl methacrylate; aminoisopropyl acrylate; aminoisopropyl methacrylate; aminobutyl acrylate; aminobutyl methacrylate; aminohexyl acrylate; aminohexyl methacrylate; aminooctadecyl methacrylate; aminooctadecyl acrylate; aminolauryl methacrylate; aminolauryl acrylate; N,N-dimethyl-aminoethyl acrylate; N,N-dimethylaminoethyl methacrylate; N,N-diethylaminoethyl acrylate; N,N-diethylaminoethyl methacrylate; piperidino-N-ethyl acrylate; vinyl propionate; vinyl acetate; vinyl butyrate; vinyl butyl ether; and vinyl propyl ether.

Preferably, the ratio of a matrix binder in an ionic transporting nano composite will vary from about 0.01% wt to about 95% wt. More preferably, the rate is in a range from about 1% wt to about 80% wt

The additives that can be added to improve electrochemical performance are as follows:
a) Electron acceptor molecules (aliphatic and aromatic compounds carrying functional groups —COOH, —OH, —SH, —CN, —NO2, —SO2, —Cl, —I, —Br, —F, —SO2Cl, —SO2F, —SO3H, —S), Tetrathiafulvalene, 1,3,4,6-Tetrathiapentalene-2,5-dione, tetronic acid, nitrobenzene, 4-nitrobenzenediazonium hexafluorophosphate, and 3-nitrobenzenesulfonic acid sodium salt.
b) Electron donor molecules (aliphatic and aromatic compounds carrying functional groups —NH2, —NH, —N, —P, . . . ) or alkaline materials (NaOH, KOH, . . . )
c) Bipolar molecules (aliphatic and aromatic compounds carrying both functional groups electron acceptor and electron donor, general polyaminoacids, sulfanilic acids, aminobenzoic acid, 2,5-Diaminobenzenesulfonic acid, 3,4-diaminobenzophenone, 1,2-Diaminoanthraquinone, nitroindole, 2-nitroimidazole, 5-nitroanthanilic acid, 2-nitroaniline, 4′-Nitroacetanilide, and 5-Nitrobenzimidazole.
   Though the mechanism is not well understood yet, these additives seem to stabilize the out put voltage as well as to improve the output voltage. The amount of additives can vary in a range from about 0.001% wt to about 50% wt, or more particularly, the variation will be in a range from about 0.01% wt to about 30% wt.

A crosslinker can be added to stabilize the ionic transporting elements and to minimize the outlet of water. Due to the high transport mobility of protons through a proton exchange membrane (PEM) utilizing an ionic transporting nano composite membrane, a large amount of water can be generated. Use of crosslinker additives will reduce the mobility of the ionic species and reduce damage to the membrane. The crosslinkers can be selected from the following: multivalent salts and polymeric crosslinkers such as polyethylene imine, polypropyleneimine, or polyvinyl alcohol with or without heat treatment. In the case when the ionic transport groups is —COOH, it can be crosslinked with —OH polymers such as hydroxylated polyester, polyvinyl alcohol, or poly vinyl butyral.

The polymeric binder(s) can be mixed with ionic transporting nano elements by a conventional mixing process including ball milling, paint shaking, microfluidizer, attritor, high speed blender and mixer, small media miller, roll miller, and magnetic stirrer. The mixing time depends upon the milling device and the interaction between the matrix media and the ionic transporting element. The proper mixing process can give rise to a slurry that is ready to form a nano composite membrane.

Other additives can be added in the mixture of polymers and ionic transporting nano elements to improve the coating and film forming performance are surfactants. Suitable surfactants can be selected depend upon the coating solvent system. For example, DC510 from the Dow Chemical Company (USA), Dowfax, Surfynol from Air Products Company (USA), and Solperse 27000 from ICI Company (USA) are suitable surfactants.

The slurry forming ionic transport composite can be deposited on a substrate containing gas diffusion layer (GDL) and a electrocatalyst layer (for example Pt, Ru and other transition metals or the like) by many different procedures, including those that are well-known in the arts—such as spray coating, blade coating, roll coating, brush painting, dip coating, bar coating, spin coating, hopper coating, inkjet printing, etc.

The electrolytic membrane can be baked at suitable temperature and baking time to eliminate the mixing solvent.

Implementations using the above cited materials give much more choices to form a desirable membrane in an economic way as compared to the prior arts based on the Nafion™ membrane.

### EXAMPLES

### Example 1

### Preparation of Carbon/Pt Electrocatalyst

50 g of carbon black Vulcan XC72R was placed into a vacuum chamber of a sputter, a component of SEM equipment from JEOL (Japan Victor Company). The vacuum was set to reach the level of 10⁻⁷ Torr. Next, the Pt bombardement on the carbon black powder was occurred at the level of 50 nm/min. The reaction occurred within 15 minutes. Then the exhaustion system was removed and the sample was out of the chamber. The carbon black product carrying Pt was mixed again with spatula and re-bombarded. The same process was repeated 10 times until the Pt weight on carbon was detected to be 30% wt. This is electrocatalyst 1A for cathode.

### Example 2

### Preparation of Carbon/Pt/Ru electrocatalyst

The same process of example 1 was repeated with 20 g of catalyst 1A above mentioned except that the Pt target is replaced by Ru. The end product is detected to be Vulcan XC72R/20% Pt/10% Ru. This is electrocatalyst 1B for anode.

### Example 3

### Preparation of Anode

5 g of electrocatalyst 1B was blended with 5 g of crosslinkable polyurethane (50% solid), 0.625 g of hardenner, 10 g MIBK (Methyl isobutyl ketone) using high speed mixer (Dispermat) for 30 minutes. The black slurry was coated on a Toray Carbon Paper (TCP) using a doctor blade to achieve electrocatalyst layer of 10 um thick after being baked at 100 C for 30 minutes. The active area of the electrode is controlled to be 1 cm2.

### Example 4

### Preparation of Cathode

Repeat example 3 except that electrocatalyst 1A is used instead of electrocatalyst 1B

### Example 5

### Preparation of Ionic Transporting Nano Elements

Preparation of ionic transporting carbon product: In a 500 ml glass beaker, 10 g of NaNOsub2 was completely dissolved in 100 g of distilled water.

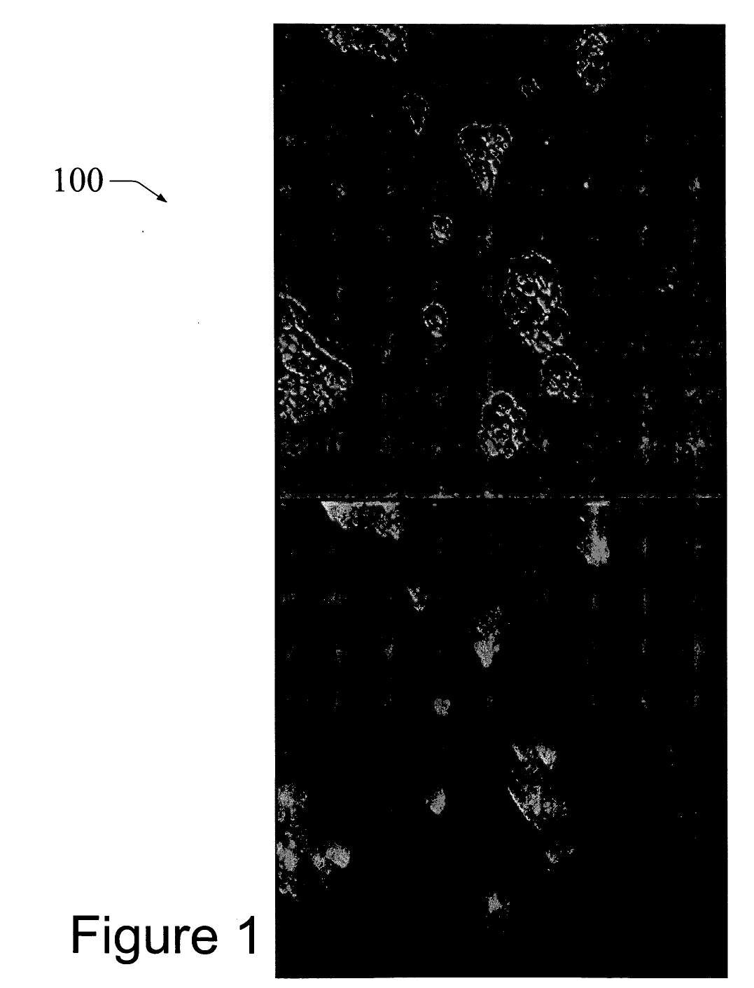

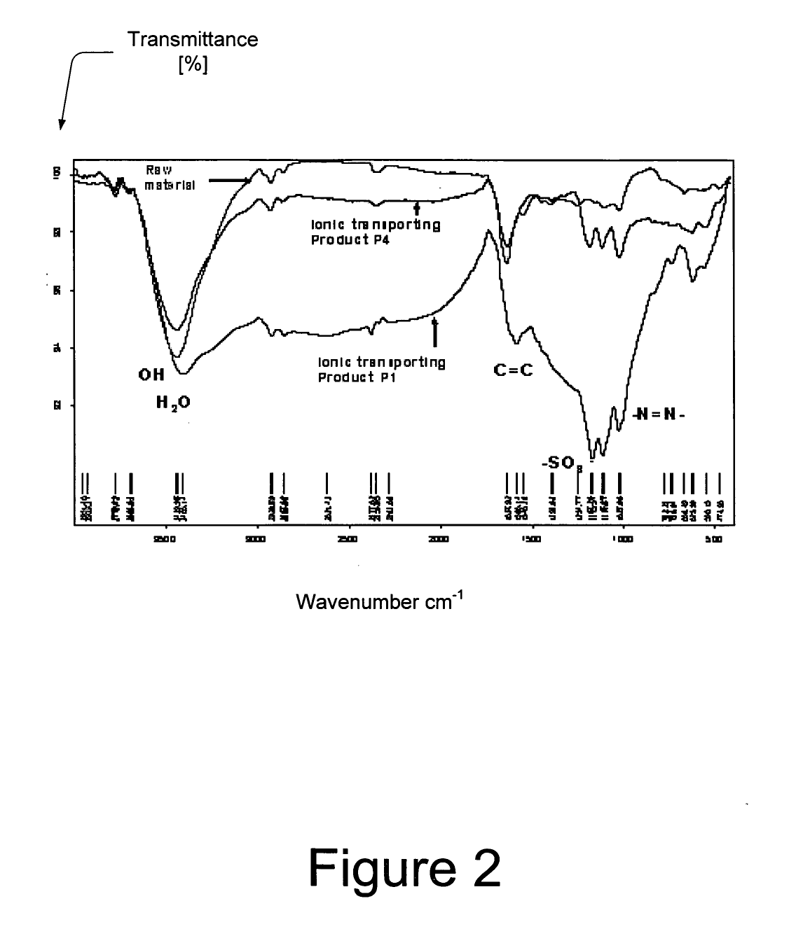

Next 50 g of carbon black (average particle size 3-5 um) prepared by the pyrrolysis of palm wicker (originated in Ben Tre province of Viet Nam) was magnetically stirred with 20 g of 2-aminoethane sulfonic acid (Aldrich Chemical, cat NO 15,224-2) in 100 g of 100 C heated MIBK for 2 hrs to assure the complete dissolution of acid compound. Next, the system was cooled at 80 C and the NaNOsub2 solution was dropped wise. The whole system was continuously heated until all of solvent went off. The black powder was baked at 140 C for 4 hrs. The product was washed with warm acetone and purified from hot water. The average particle size of the final product was detected to be 20-30 nm by Veeco AFM (stepping mode) (see FIG. 1). This is called as ionic transporting carbon product P1. The same reaction process was repeated on the product P1 4 times to achieve ionic transporting carbon product P4. As illustrated in FIG. 2, there is an exhibition of IR absorption spectra of the raw material, product P1 and product P4, revealing the successful attachment of —CH2-SO3H onto the palm wicker originated carbon. Product yield was detected to be 75%.

Preparation of ionic transporting composite membrane: Next 25 g of product P4 was blended with 70 g of emulsion copolymer (styrene-acrylic) from Chemcor 43C30 (37% solid) in 10 g of ethanol using a ceramic jar and a roll miller for 3 hrs. The slurry was doctor blade coated on a Teflon substrate to achieve a thick black film of 177 um after being baked at 80 C for 2 hrs. The dried film was peeled off from the Teflon substrate very easily

### Example 6

### Preparation of Ionic Transporting Composit Membrane and Test the Membrane

First, the membrane fabricated in Example 5b) was sandwitched between anode 1B and cathode 1A described in example 3 and 4 and press-heated together using a press bonder set at 120 C under a pressure of 300 psi, for 20 minutes. This process yields an assembly ready for fuel cell. After being cooled off, the fuel cell assembly was incorporated in an in-house Direct Methanol Fuel Cell (DMFC). Two electrodes are connected to a voltage meter and a current meter in the outside loop.

Next, 5 ml of the mixed solution of 10% methanol in water was fed into the cell. Immediately, the output voltage quickly rams up giving the output voltage described in Table 1, without any pre- exercise of the cell.

| | Output voltage |
|---|---|
| Time (sec) | (mV) |
| 0.0 | 1.2 |
| 1.0 | 75 |
| 2.0 | 150 |
| 4.0 | 220 |
| 8.0 | 550 |
| 16.0 | 700 |
| 32.0 | 700 |
| 60.0 | 700 |

The maximum current was measured to be 70 mA.

Comparison example 1 Repeat example 6 except that the commercial product Nafion 117 (Dupont) membrane having the same was used instead. The thickness of the commercial membrane is 178 um. As a result, Nafion 117 exhibits the out put voltage of 633 mV and a maximum current density of 50 mA

### Example 7

Repeat example 6 except that pal wicker originated carbon black is replaced by various carbon product raw materials. And the result is summarized in the following Table 2:

| | | | Maximum | |
|---|---|---|---|---|
| | | Ionic group | output | |
| | Carbon product | attachment | voltage | Maximum |
| Example | raw materials | yield | (mV) | current (mA) |
| 7a | Dust coal | 30% | 600 | 52 |
| 7b | Mudd coal | 34% | 650 | 54 |
| 7c | Charcoal | 52% | 550 | 51 |
| 7d | Fume carbon black | 90% | 700 | 62 |
| | from pine wood | | | |
| | burning | | | |
| 7e | Fume carbon black | 98% | 750 | 75 |
| | from acetylene gas | | | |
| | pyrrolysis | | | |
| 7f | Fume carbon black | 76% | 632 | 53 |
| | from sugar burning | | | |
| 7g | Fume carbon black | 55% | 650 | 52 |
| | from paddy shell | | | |
| | burning | | | |
| 7h | Fume carbon black | 83% | 600 | 55 |
| | from rubber waste | | | |
| | burning | | | |
| 7i | Fume carbon black | 90% | 650 | 70 |
| | from diesel oil | | | |
| | burning | | | |
| 7j | Fume carbon black | 90% | 621 | 80 |
| | from kerosene oil | | | |
| | burning | | | |
| 7k | Cabojet 200 | undetectable | 585 | 62 |
| 7l | Cabojet 300 | undetectable | 623 | 39 |
| 7m | Carbon nanotube | 46% | 500 | 78.0 |
| | (Zyvex) | | | |
| 7n | Fullerene | 38% | 530 | 59.0 |
| 7o | Fume carbon black | >95% | 670 | 62.0 |
| | from terpentine oil | | | |
| | burning | | | |

### Example 8

Repeat example 6, except that the ionic transporting carbon black is replaced by commercial products. Results are summarized in the following Table 3:

| | | Maximum | Maximum | Membrane |
|---|---|---|---|---|
| | Ionic transporting | output voltage | current | resistivity |
| Example | carbon black | (mV) | (mA) | (kOhm-cm) |
| 8a | CB200 (Cabot) | 590 | 21.0 | 0.75 |
| 8b | CB300 (Cabot) | 500 | 6.0 | 0.90 |

### Example 9

Study the membrane composed of ionic transporting carbon black doped with electron acceptor,electron donor and bimolecules Repeat example 6, except that the electrocatalyst of anode and cathode electrode described in example 2 and 3 was doped with 3% of KOH. The result was summarized in the following Table 4:

| | Maximum out put voltage | Maximum current |
|---|---|---|
| Example | (mV) | (mA) |
| 6 | 700 | 70.0 |
| 9 | 850 | 85.0 |

### Example 10

Study the membrane composed of ionic transporting carbon black doped with electron acceptor,electron donor and bimolecules Repeat example 6, except that the electrocatalyst of anode and cathode electrode described in example 2 and 3 was doped with 1% of sulfanilic acid. The result was summarized in the following Table 5:

| | Maximum out put voltage | Maximum current density |
|---|---|---|
| Example | (mV) | (mA) |
| 6 | 700 | 70.0 |
| 10 | 790 | 82.0 |

### Example 11

### Study the Membrane Composed of Ionic Transporting Dyes Molecules Embedded in Polymer Matrix

Repeat example 6, except that the ionic transporting nano element is acid blue 9 instead of ionic transporting nano carbon product. In this case, 10 g of acid blue 9 solution (50% solid, product of Chromatech Inc) was blended with 10 g of emulsion polymer Nuplex 9052 (Nuplex, Inc, 50% solid) by ball milling for 30 minutes. The result was summarized in the following Table 5:

| | Maximum out put | Maximum current |
|---|---|---|
| Example | voltage (mV) | density (mA) |
| No dye (acid | −0.2 | undetectable |
| blue 9) polymer film | | |
| 11 | 550 | 48.5 |

### Example 12

### Study the Membrane Composed of Ionic Transporting Dyes Molecules Adsorbed on Semiconducting Powder and then Embedded in Polymer

Repeat example 6, except that the ionic transporting nano element is ionic transporting dyes molecules adsorbed on semiconducting powder instead of ionic transporting nano carbon product. In this case, ionic transporting dyes molecules adsorbed on semiconducting powder is prepared by the following procedure: 5 g of acid Red 114 (Aldrich Chemical, Cat No 21,031-5), 10 g of ZnO (Sazex 2000, Sakai Kagaku), was blended in 100 g of mixed solvent of water and MEK (1:1 ratio), 10 g of emulsion polymer Nuplex 9052 (Nuplex, Inc, 50% solid). The whole system was balled milled in a ceramic jar for 48 hrs using ceramic ball (3 mm diameter) to achieve a pink slurry. For comparison Example 12a), Example 12 was repeated except that the acid Red dye was not added. The result was summarized in the following Table 6:

| | Maximum out put | Maximum current density |
|---|---|---|
| Example | voltage (mV) | (mA) |
| 12 | 612 | 34.0 |
| Comparison Ex 12 a) | 1.2 | undetectable |

### Example 13

### Study the Proton Transfer Efficiency in the Composite Membrane

It has been known (A) from the prior arts that Pt is one of effective catalyst which can generate proton H+ from the hydrogen gas or from the alcohols such as methanol, ethanol . . . . The proton is generated in the anode and migrates to cathode to form water when contacts with oxygen in the air. The following test proves that the composit membrane is an ionic transporting one. Repeat example 6 except that the electrocatalyst in Ex 3 and 4 do not contain any Pt or Ru. As a result, there is no water observed in the cathode

### Example 14

Study the effect of polymer in the membrane: Repeat example 6 except that the Chemcor emulsion polymer is replaced by various polymers. The results are listed in the following Table 7:

| | | | | | Polymer |
|---|---|---|---|---|---|
| | | | | | swollen at |
| | | | Maximum | Maximum | 150 C after |
| | | | out put | current | 10 hrs |
| | | | voltage | density | soaked in |
| Example | Polymer | Crosslinker | (mV) | (mA) | water/MeOH |
| 14-1 | Gelatine (70%) | Polyimine | 720 | 60.0 | none |
| | | (30%) | | | |
| 14-2 | Ebeccryl 2002 | Hardenner(25%) | 613 | 65.0 | none |
| | (Polyurethane) | | | | |
| | (75%) | | | | |
| Comparison | | | 633 | 50.0 | Almost |
| Nafion 117 | | | | | completely |
| | | | | | dissolved |

### Example 15

### Study Heat Treatment Effect

Repeat example 6 except that the ionic transporting nano carbon from palm wicker was annealed in an oven at 300 C for 45 min. After being cooled off, the material was incorporated into the composit membrane. The test result is summarized in the following Table 8:

| | Maximum out put | Maximum current density |
|---|---|---|
| Example | voltage (mV) | (mA) |
| 15 | 700 | 82.0 |
| 6 (no heat treatment | 700 | 70.0 |
| before composit) | | |

### Example 16

### Study Effect of Ionic Polymer as Membrane Binder

Repeat example 6 except that the emulsion polymer is replaced by Nafion polymer (2101 from Dupont, 21% solid). The test result is summarized in the following Table 9:

| | Maximum out put | Maximum current density |
|---|---|---|
| Example | voltage (mV) | (mA) |
| 6 | 700 | 70.0 |
| (EmulPolymer/carbon | | |
| ratio = 1/1) | | |
| Comparison Example | 633 | 50.0 |
| 1 (Nafion) | | |
| Example 16-1 | 721 | 73.0 |
| (Nafion/carbon = 1/1) | | |
| Example 16-2 | 750 | 75.0 |
| (Nafion/Carbon = 1/2) | | |

While preferred embodiments of this invention have been shown and described, modifications thereof can be made by one skilled in the art without departing from the spirit or teaching of this invention. The embodiments described herein are exemplary only and are not limiting. Many variations and modifications of the method and any apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

What is claimed is:

1. An electrolyte membrane comprising a plurality of particles each having a size in a range from about 500 microns to about 1 nanometer, said plurality of particles being suitable to transport ionic groups across the electrolyte membrane, wherein the ionic groups are selected from the group consisting of anions, cations, switter ions, and combinations thereof.

2. The electrolyte membrane as defined in claim 1, wherein the particles are selected from the group consisting of nanospheres, nanorods, nanocups, nanowires, nano tubes, semiconductor quantum dots, nanocrystals, and combinations thereof.

3. The electrolyte membrane as defined in claim 1, further comprising a polymer selected from group consisting of a polyaminoacid, an emulsion polymer, an ionic polymer, a water soluble polymer, an organic solvent soluble polymer, a fluoropolymer, a liquid crystal polymer, a crosslinking polymer, and combinations thereof.

4. The electrolyte membrane as defined in claim 2, wherein the polyaminoacid is selected from group consisting of gelatin, protein, egg albumin, and combinations thereof.

5. The electrolyte membrane as defined in claim 2, wherein the crosslinking polymer is selected from group consisting of an ultraviolet curable resin, a thermal curable resin, a network polymer, and combinations thereof.

6. The electrolyte membrane as defined in claim 1, wherein the plurality of particles further comprise an ionic species selected from the group consisting of a dye stuff, a surfactant, a charge control agent, salts and combinations thereof.

7. A membrane-electrode assembly fabricated using the electrolyte membrane as defined in claim 1.

8. A fuel cell fabricated using the membrane-electrode assembly as defined in claim 6.

9. The fuel cell as defined in claim 7, wherein the fuel cell comprises:
an internal structure including:
a current collector;
an anode;
the electrolyte membrane;
a cathode;
a current collector; and
means, connected to the anode and the cathode, for providing fuel and an oxidizing agent; and
means for encapsulating the internal structure.

10. An electrolyte membrane comprising nanoparticles each characterized by a size in a range from about 500 microns to about 1 nanometer, the nanoparticles including carbon products having an ion transportation property suitable to carry ionic groups between opposing surfaces of the electrolyte membrane, wherein the ionic groups are selected from the group consisting of anions, cations, switter ions, and combinations thereof.

11. The electrolyte membrane as defined in claim 10, wherein the nanoparticles including carbon products are selected from the group consisting of buckyballs, carbon nanotubes, carbon nanohorns, carbon nanofibers, nano sphere/powder, quantum dots, metal encapsulated buckyballs, nanoparticles that incorporate carbon, carbon fibers bonded to or contacting the nanoparticles, and combinations thereof.

12. The electrolyte membrane as defined in claim 10, wherein the nanoparticles are selected from the group consisting of carbon nanotubes, carbon nanostructures, graphite-encapsulated metal particles, carbon fibrils, carbon nanoshells, and carbon nanofibers, and combinations thereof.

13. The electrolyte membrane as defined in claim 10, wherein:
the carbon products have an attached a chemical finctional group that provides the carbon products with the ion transportation property; and
the chemical finctional group, which is converted into a salt, is selected from the group consisting of an acidic group and an amine group.

14. The electrolyte membrane as defined in claim 10, wherein the carbon products comprise rubber, a polymer, a sugar or sugar derivative, activated carbon, carbon nano tubes, carbon nano horns, carbon black, graphite, fullerenes, diamonds, wood coal, charcoal, mud coal, a thermal decomposed or burned product comprising carbon atom containing materials, and combinations thereof.

15. The electrolyte membrane as defined in claim 14, wherein the carbon atom containing materials are selected from the group consisting of hydrocarbons, aliphatic and aromatic acids, alcohols, aldehydes, ketones, nitro compounds, amino compounds, cellulose products, and combinations thereof.

16. The electrolyte membrane as defined in claim 15, wherein the cellulose products are selected from the group consisting of palm wicker, coconut shell, paddy shell, pine wood, oil products, and combinations thereof.

17. The electrolyte membrane as defined in claim 16, wherein the oil products are selected from the group consisting of diesel oils, kerosene oils, and combinations thereof.

18. A membrane-electrode assembly fabricated using the electrolyte membrane as defined in claim 10.

19. A fuel cell fabricated using the membrane-electrode assembly as defined in claim 18.

20. The fuel cell as defined in claim 19, wherein the fuel cell comprises:
an internal structure including:
a current collector;
an anode;
the electrolyte membrane;
a cathode;
a current collector; and
means, connected to the anode and the cathode, for providing fuel and an oxidizing agent; and
means for encapsulating the internal structure.

21. An electrolyte membrane comprising nanoparticles embedded in a polymer matrix, wherein:
the nanoparticles have an ion transportation property sufficient to transport ionic species through the electrolyte member; and
the ionic species are selected from the group consisting of anions, cations, switter ions, and combinations thereof.

22. The electrolyte membrane as defined in claim 21, wherein the ion transportation property is provided to the nanoparticles by a base salt.

23. The electrolyte membrane as defined in claim 22, wherein the base salt includes ionic species selected from the group consisting of —SO3H, —COOH, —NH2, —NH, —N, —OH, and combinations thereof.

24. The electrolyte membrane as defined in claim 21, wherein the ion transportation property is provided to the nanoparticles by a selection from the group consisting of an acid salt, base salt, acid, and base.

25. The electrolyte membrane as defined in claim 24, wherein the acid salt comprises carbonium salt, pyrrylium salt, iodonium salt, sulfonium salts, ammonium salt, phosphonium salt, and combinations thereof.

26. The electrolyte membrane as defined in claim 21, wherein the ion transportation property is provided to the nanoparticles by an amino acid.

27. The electrolyte membrane as defined in claim 21, wherein the polymer matrix comprises a polymeric binder in which the nanoparticles are embedded.

28. The electrolyte membrane as defined in claim 24, wherein the polymeric binder further comprises an additive selected from the group consisting of an acid, a base, electron acceptor molecules, electron donor molecules, bipolar molecules, and combinations thereof.

29. The electrolyte membrane as defined in claim 24, wherein the polymeric binder is selected from the group consisting of an aqueous emulsion polymer, a copolymer of a vinyl monomer, a polyamino acid, a crosslinking polymer, an aldehyde polymer, a water soluble polymer, a fluoro polymer, an ionic polymer, a polyN-vinyl carbazol polymer, a poly carbonate, a poly ester, a polyimide, an acrylic resin, a poly styrene, and combinations thereof.

30. The electrolyte membrane as defined in claim 25, wherein the polyamino acid is selected from the group consisting of gelatin, protein, egg albumin, collagen, casein, and polygamma-benzylglutamate.

31. A membrane-electrode assembly fabricated using the electrolyte membrane as defined in claim 21.

32. A fuel cell fabricated using the membrane-electrode assembly as defined in claim 31.

33. The fuel cell as defined in claim 32, wherein the fuel cell comprises:
an internal structure including:
a current collector;
an anode;
the electrolyte membrane;
a cathode;
a current collector; and
means, connected to the anode and the cathode, for providing fuel and an oxidizing agent; and
means for encapsulating the internal structure.

34. A fuel cell comprising:
an electronically non-conductive membrane including a polymeric binder having embedded nanoparticles rendering the membrane conductive to ionic groups selected from the group consisting of anions, cations, switter ions, and combinations thereof;
an anode and an opposing cathode on opposite sides of the membrane;
a catalyst on the anode;
a catalyst on the cathode;
a gas diffusion layer contacting the anode and having a plurality of openings therein to allow fuel from the fuel source to pass through to the anode, as fuel is consumed at the anode; and
a gas diffusion layer contacting the cathode and having a plurality of openings therein to allow oxygen to pass through to the cathode.

35. A method of generating power using the fuel cell as defined in claim 34, the method comprising:
introducing fuel from a fuel source into the plurality of openings in the gas diffusion layer contacting the anode so as to contact the catalyst on the anode; and
introducing oxygen into the plurality of openings in the gas diffusion layer contacting the cathode so as to contact the catalyst on the cathode;
whereby an electricity-generating reaction occurs as the fuel is consumed at the anode by:
an anodic dissociation of the fuel into protons, electrons, and a gaseous reaction product; and
a cathodic combination of protons, electrons, and the oxygen, thereby producing water.

36. The method as defined in claim 34, wherein the fuel is selected from the group consisting of hydrogen, methanol, ethanol, and propanol.
